(19) United States
(12) Patent Application Publication
(10) Pub. No.: US 2017/0083623 A1
(43) Pub. Date: Mar. 23, 2017

(54) SEMANTIC MULTISENSORY EMBEDDINGS FOR VIDEO SEARCH BY TEXT

(71) Applicant: QUALCOMM Incorporated, San Diego, CA (US)

(72) Inventors: Amirhossein HABIBIAN, Amsterdam (NL); Thomas Edgar Josef MENSINK, Amsterdam (NL); Cornelis Gerardus Maria SNOEK, Volendam (NL)

(21) Appl. No.: 15/080,501

(22) Filed: Mar. 24, 2016

Related U.S. Application Data
(60) Provisional application No. 62/221,569, filed on Sep. 21, 2015.

(51) Int. Cl. G06F 17/30; G06N 99/00

(52) U.S. Cl. CPC G06F 17/30823; G06N 99/005; G06F 17/30675

(57) ABSTRACT

A method of embedding video for text search includes extracting visual features from a video. The visual features may, for example, include appearance information, motion, audio, and/or like features. Term vectors are determined from textual descriptions associated with the video. The text may be included in a title for the video or included within the video (e.g., subtitles), for example. A feature projection is computed based on the extracted video features and a textual projection is computed based on the term vectors. A semantic embedding is computed based on the feature projection and the textual projection by jointly optimizing semantic predictability and semantic descriptiveness.

### CROSS-REFERENCE TO RELATED APPLICATION

The present application claims the benefit of U.S. Provisional Patent Application No. 62/221,569, filed on Sep. 21, 2015, and titled “SEMANTIC MULTISENSORY EMBEDDINGS FOR VIDEO SEARCH BY TEXT,” the disclosure of which is expressly incorporated by reference herein in its entirety.

### BACKGROUND

Field

Certain aspects of the present disclosure generally relate to computer vision, multimedia analysis, and machine learning and, more particularly, to improving systems and methods of embedding video to enable text-based searching capabilities.

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In an aspect of the present disclosure, a method of embedding video for text search is presented. The method includes jointly optimizing semantic predictability and semantic descriptiveness. Semantic predictability and semantic descriptiveness are jointly optimized by learning the embedding based on terms included in a query and by learning the embedding based on multimodal analysis of the video.

In another aspect, an apparatus for embedding video for text search is presented. The apparatus includes a memory and at least one processor. The one or more processors are coupled to the memory. The processor(s) is(are) configured to jointly optimize semantic predictability and semantic descriptiveness. Semantic predictability and semantic descriptiveness are jointly optimized by learning the embedding based on terms included in a query and by learning the embedding based on multimodal analysis of the video.

In yet another aspect, an apparatus for embedding video for text search is presented. The apparatus includes means for jointly optimizing semantic predictability and semantic descriptiveness. Semantic predictability and semantic descriptiveness are jointly optimized by learning the embedding based on terms included in a query and by learning the embedding based on multimodal analysis of the video. The apparatus also includes means for predicting an event in the video based on the embedding.

In still another aspect, a non-transitory computer readable medium is presented. The non-transitory computer readable medium has encoded thereon program code for embedding video for text search. The program code is executed by a processor and includes program code to jointly optimize semantic predictability and semantic descriptiveness. Semantic predictability and semantic descriptiveness are jointly optimized by learning the embedding based on terms included in a query and by learning the embedding based on multimodal analysis of the video.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary process for training and embedding in accordance with aspects of the present disclosure.

FIG. 5 is a line graph illustrating an exemplary joint optimization based on the example of FIG. 4.

FIG. 6 is a diagram illustrating exemplary prediction of contents of a video in accordance with aspects of the present disclosure.

FIG. 7 is an example text-based search query in accordance with aspects of the present disclosure.

FIG. 8 illustrates a method for embedding video for a text search according to aspects of the present disclosure.

FIG. 9 illustrates a method for training and embedding in accordance with aspects of the present disclosure.

FIG. 10 illustrates a method for video retrieval in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Semantic Multisensory Embedding for Video Search by Text

Video search solutions may provide access to video based on text derived from filenames, surrounding text, social tagging, closed captions, or the speech transcript. This results in disappointing retrieval performance when the visual content is not mentioned, or properly reflected in the associated text. Additionally, when the video originates from non-English speaking countries, querying content becomes much more difficult as robust automatic speech recognition results from accurate machine translations are difficult to achieve. In cases where no text can be associated to the video content at such time, these technologies produce undesirable results.

To provide for more robust video retrieval, concept detectors may be used. Concept detectors are related to objects, scenes, people, and events. Concept detectors assign a probability of concept presence to a piece of video content, which at search time can be leveraged for retrieval by sorting pieces of video content according to the probability of the concept presence. However, for concept detectors, each individual detector requires a separate set of videos and their concept level labels to learn from during training. Concept detectors involve a significant manual annotation effort to specify a universal vocabulary of concepts and to provide positive and negative videos for each concept for training. Such a large manual annotation effort is restrictive (e.g., it is not scalable) when constructing a comprehensive set of concept detectors to match the vocabulary of the user.

Instead of learning the concept from video for each possible text query a priori, aspects of the present disclosure are directed to learning a meaningful video representation. At training time, a semantic multisensory embedding may be learned from a large amount of video and their text descriptions that may be noisy (e.g., includes misspelled words, typographical errors, uncommon or slang terms). The text descriptions may, for example, be harvested from Internet sources and the like. At search time, the representation or learned embedding may provide for any text video retrieval request without any video or image example.

In accordance with aspects of the present disclosure, one goal is to learn a representation function ƒ:X→S, which maps each low-level video representation xᵢεX, into the semantic representation sᵢεS. Low-level video representations are standard non-semantic descriptors, which may be extracted by a pre-trained convolutional neural network, or by aggregating the handcrafted video descriptors such as by scale invariant feature transform (SIFT) and histogram of oriented gradients (HOG).

The representation function may be trained on a collection of videos and their semantic labels, which may comprise term vectors from descriptions [symbol] ε [symbol] .

The trivial approach for learning the representation function is to stack a set of binary classifiers, which predict the presence/absence of each individual term in descriptions given the video features. However, predicting the terms individually suffers from two main drawbacks. First, most of the terms rarely occur in the descriptions. For these infrequent terms, there are not enough positive examples available to train reliable visual classifiers. Second, the term vectors are highly noisy and incomplete, which limits their reliability to be directly used as a source of supervision for training visual classifiers. Therefore, aspects of the present disclosure are directed to learning a semantic representation on a lower dimensional projection of the term vectors, which have been shown to be less sparse and less noisy.

The representation function may be formulated as a multi-modal embedding, which may be referred to as a VideoStory embedding or representation. The embedding is learned in a joint optimization framework which balances:

1) Descriptiveness, to preserve the information encoded in the video descriptions as much as possible, and

2) Predictability, to ensure that the representation could be effectively recognized from video content.

### VideoStory Framework

A dataset of videos may be represented by video features Xε [symbol] where D represents the dimensionality of visual features and N represents the number of videos. The textual descriptions for the videos may be represented by binary term vectors Yε(0, 1)^{M×N}, indicating which terms are present in each video description, where M is the number of unique terms in descriptions. The VideoStory representation may be learned by minimizing:

$${L}_{vs} ( A , W ) = {min}_{S} {L}_{d} ( A , S ) + {L}_{p} ( S , W ) , \qquad ( 1 )$$

where Aε [symbol] a textual projection matrix, Wε [symbol] is a visual projection matrix, and Sε [symbol] is the VideoStory embedding. The loss function L_{d} corresponds to a first objective for learning a descriptive VideoStory, and the loss function Lₚ corresponds to a second objective for learning a predictable VideoStory. The VideoStory embedding S serves as an interconnection between the two loss functions.

### Descriptiveness

The L_{d} function minimizes the quadratic error between the original video descriptions Y, and the reconstructed translations obtained from A and S:

$${L}_{d} ( A , S ) = \frac{1}{N} {\sum }_{i = 1}^{N} {‖ {y}_{i} - A {s}_{i} ‖}_{2}^{2} + {λ}_{α} Ω ( A ) + {λ}_{s} Ψ ( S ) , \qquad ( 2 )$$

where Ψ(•) and Ω(•) denote regularization functions, and λₐ≧0 and λₛ≧0 are regularizer coefficients. In some aspects, a matrix variant of the l₂ regularizer (e.g., Ω(A)=[[A]]_{F}²=Σᵢ∥aᵢ∥₂²=Σᵢⱼaᵢⱼ²), the sum of the squared matrix elements (the squared Frobenius norm) may be used for regularization. A similar regularization may be applied to the VideoStory matrix Ψ(S)=∥S∥_{F}².

### Predictability

The Lₚ function measures the occurred loss between the VideoStory S and the embedding of video features using W. Because the VideoStory S is real valued, as opposed to a binary or multi-class encoding, standard classification losses such as the hinge-loss used in support vector machines (SVMs) may be unreliable. Therefore, Lₚ may be defined as a regularized regression:

$${L}_{p} ( S , W ) = \frac{1}{N} {\sum }_{i = 1}^{N} {‖ {s}_{i} - {W}^{T} {x}_{i} ‖}_{2}^{2} + {λ}_{w} Θ ( W ) , \qquad ( 3 )$$

where, for example, the Frobenius norm, may be used for regularization of the visual projection matrix W, Θ(14)=∥W∥_{F}², and λ_{w} is the regularization coefficient.

### Joint Optimization

To handle large-scale data sets and state-of-the-art high-dimensional visual features, e.g., Fisher vectors on video features or deep learned representations, Stochastic Gradient Descent (SGD) optimization, or other optimization techniques may be used. One such example is provided in the pseudo code of Table 1.

TABLE 1

input : X , Y , k, η (step-size), m (max-epochs)
output: W and A
A, and S ← SVD decomposition of Y
W ← random (zero-mean)
for ε ← 1 to m do
| for i ← 1 to N do
| | Pick a random video-description pair (xₜ, yₜ)
| | Compute gradients w.r.l. A, W and sₜ
| | Update parameters:
| | A ←A − ηₜ ∇_{A} L_{VS} see Eq. (4)
| | W ←W − ηₜ ∇_{W} L_{VS} see Eq. (5)
| | S ←sₜ − ηₜ ∇ₛ_{ₜ} L_{VS} see Eq. (6)
| end
end
return: W and A

The number of passes over the datasets (epochs) and the step-size η are hyper-parameters of SGD.

The VideoStory objective function, as given in Eq. (1), is convex with respect to matrix A and W when embedding S is fixed. In that case, the joint optimization may be decoupled into Eq. (2) and Eq. (3), which may both be reduced to a standard ridge regression for a fixed S. Moreover, when both A and W are fixed, the objective in Eq. (1) is convex with respect to S. Therefore, standard SGD may be employed by computing the gradients of a sample with respect to the current value of the parameters, and S may be minimized jointly with A and W.

A randomly sampled video and description pair at step t may be represented by (xₜ, yₜ), and sₜ may represent the current VideoStory embedding of a sample t. The gradients of Eq. (1) for this sample with respect to A, W and sₜ are given by:

∇_{A}L_{VS}=−2(yₜ−Asₜ)sᵣ^{T}+λₐA, (4)

∇_{W}L_{VS}=−2xₜ(sₜ−W^{T}xₜ)^{T}+λ_{w}W, and (5)

∇ₛ_{ₜ}L_{VS}=2[sₜ−W^{T}xₜ−A^{T}(yₜ−Asₜ)]+λ₂sₜ. (6)

The effect of jointly learning the descriptiveness and the predictability, becomes clear in Eq. (6), where both the textual projection matrix A and visual projection matrix W contribute to learning the VideoStory embedding S. This embedding S may be used to obtain the textual projection A matrix, in Eq. (4), and the visual projection W matrix, in Eq. (5). In turn, this leads to the VideoStory embedding, which is both descriptive, by preserving the textual information, and predictability, by minimizing the visual prediction loss.

In some aspects, the parameters A, S, and W may be initialized by random numbers with zero-mean. Alternatively, in some aspects, the A and S matrices may initialized by singular value decomposition (SVD) of the term vectors Y, which may speed up the convergence of the learning process.

After training the visual and textual projection matrices, these matrices may be used to predict the VideoStory representation and the term vector of each video. In the case that both a video xᵢ and description yᵢ are given, the VideoStory representation may be obtained by returning sᵢ from Eq. (1), while keeping both A and W fixed. However, in practice most videos are not provided with a description. Therefore, the VideoStory representation may be predicted from the low-level features xᵢ as given by:

sᵢ=W^{T}xᵢ, (7)

Given a predicted representation sᵢ, a prediction for the term vectors may be expressed as follows:

ŷᵢ=Asᵢ, (8)

where the terms with the highest values are most relevant for this video.

### Multimodal VideoStory Embedding

Leveraging multiple modalities may be effective for understanding complex events. In some aspects, a multimodal Video Story VideoStory^{mm} embedding may be learned. That is, the VideoStory framework may be extended by incorporating multiple modalities (e.g., audio, visual aesthetic, motion video) when measuring the predictability loss. In some aspects, the terms may be combined only if they are similar in all of the modalities. This may prevent combination of terms that are visually similar, but are dissimilar in other feature spaces, namely, audio and motion (e.g., bird and airplane or signing and crying), for example.

The learned visual projection matrix W predicts the VideoStory representation from low-level video features. The textual projection matrix A predicts the term vector from the VideoStory representation.

To this end, the single modality predictability loss from Eq. (3) may be replaced with a weighted combination of per modality predictability losses:

$${L}_{p}^{mm} ( S , W ) = {\sum }_{j = 1}^{J} {γ}_{j} {L}_{p} ( S , {W}^{j} ) \qquad ( 9 )$$

where S is the multimodal VideoStory representations, and W=(W^{j}, j=1 . . . 1) is a set including the feature projection matrices from all of the J modalities. Each feature projection matrix W^{j}ε [symbol] projects the low-level feature xᵢ^{j}ε [symbol] extracted from the video, for example, audio and/or motion descriptors into its corresponding VideoStory representation. Moreover, γⱼ≧0 is a parameter to weight the importance of each modality in learning the VideoStory representation. In some aspects, the γⱼ parameters may be initialized to 1. On the other hand, the γⱼ parameters may also be optimized by cross-validation if sufficient training examples are available.

The objective function Eq. (1) is still convex with respect to the parameters S, A, and W^{j} when the other parameters are fixed. However, the gradient with respect to sₜ, Eq. (6) may be given by:

$${∇}_{{s}_{t}} {L}_{vs} = 2 ⌈ {s}_{t} - {\sum }_{j} {γ}_{j} {W}^{jT} {x}_{t}^{j} - {A}^{T} ( {y}_{t} - {As}_{t} ) ⌉ + {λ}_{s} {s}_{t} . \qquad ( 10 )$$

It can be seen that all the modalities are jointly contributing to learn the multimodal VideoStory embedding S.

Where both video features xᵢ^{j} and description yᵢ are given, the multimodal VideoStory representation may be obtained by returning sᵢ from Eq. (1), while keeping the A and W fixed. Otherwise, learned feature projection matrices may be used to extract the representation. Each feature projection matrix W^{j} predicts the VideoStory representation based on its underlying modality as follows:

sᵢ^{j}=W^{j}^{^{T}}xᵢ^{j}. (11)

The final multimodal representation may be obtained by aggregating the per modality representations, for example, by averaging, concatenation, or kernel pooling. By aggregating over the modalities, undesirable combinations may be penalized (e.g., bird and plane), thereby preventing undesirable combinations for grouping of terms and reducing predictability loss over all of the modalities.

### VideoStory for Text-Based Video Search

As discussed above, the descriptiveness loss L_{d} is defined as the overall error in reconstructing all the terms from the VideoStory representations. With this definition, the descriptiveness loss is biased toward the more frequent terms, as minimizing their reconstruction error leads to a higher decrease in the overall error. Consequently, the terms that are infrequent in the descriptions may be discarded, which may degrade their prediction accuracy from video features. This may undermine the effectiveness of our representation learning for text-based video search, where the accuracy in predicting the query terms from video may be more important.

To address this, in some aspects, the VideoStory framework may learn a video representation that is effective for text-based video search. This VideoStory extension may be referred to as VideoStory⁰. VideoStory⁰ minimizes the reconstruction error of the terms with respect to their importance for describing the events, rather than their frequency in the VideoStory training data. For this purpose, a term sensitive descriptiveness loss may be given by:

$${L}_{d}^{ts} ( A , S ) = \frac{1}{N} {\sum }_{i = 1}^{N} {‖ {H}^{\frac{1}{2}} ( {y}_{i} - {As}_{i} ) ‖}_{2}^{2} + {λ}_{α} Ω ( A ) + {λ}_{s} Ψ ( S ) , \qquad ( 12 )$$

where Hε [symbol] is a diagonal matrix, denoting the importance of each term for describing the events. By setting a relatively high value for hⱼⱼ for term j, its reconstruction error is more penalized compared to the other terms. Hence, the term is expected to be more precisely reconstructed.

The term importance matrix H may be determined by relying on the presence or absence of terms in the textual event definitions. The term importance matrix may be provided or determined, for example, via a query of text, audio or the like. In some aspects, terms that are present in event definitions are more important than the absent terms. Each element of the importance matrix hⱼⱼ is set to α, if the term j is present, and set to 1−α if the term j is absent in the event definitions. As such, α may serve as a balancing parameter between 0 and 1. For example, to assign more importance to present terms, a may be set to a value greater than 0.5 (e.g., 0.75). The importance matrix can be extracted either separately for each event or for all the events jointly.

### Multimodal VideoStory for Text-Based Video Search

To leverage both multimodal analysis of videos and the term analysis of the text query, the following objective function may be used to train the embeddings:

$${L}_{vs} ( A , W ) = {min}_{S} {L}_{d}^{ts} ( A , S ) + {L}_{p}^{mm} ( S , W ) . \qquad ( 13 )$$

After training the visual and textual projection matrices, text-based search may be performed as follows. Each test video (e.g. an unseen video) may be represented by predicting its term vector based on Eq. (7) and Eq. (8). The textual event definition may be translated into the event query, denoted as y^{e}ε [symbol] , by matching the terms in the event definition with the M unique terms in the VideoStory training data. A ranking may be obtained by measuring the similarity between the video representations and the event query based on the cosine similarity:

$${s}_{e} ( {x}_{i} ) = \frac{{y}^{e T} {\hat{y}}_{i}}{‖ {y}^{e} ‖ ‖ {\hat{y}}_{i} ‖} \qquad ( 14 )$$

In some aspects, the highest ranked video may be presented as the search result. Alternatively, videos having a ranking above a predefined threshold may be presented.

Accordingly, an output of the learning is two projection matrices: i) a visual projection matrix W, and ii) a textual projection matrix A. After training, and at test/search time, the learned projection matrices A and W may be beneficially used for text based video search of videos with or without text labels. For example, for each test video (an unseen video), the terms (y) may be predicted by applying the learned visual and textual projections consecutively as in Equations 7 and 8. The output is the predicted term vector y for the unseen video. When a textual query is requested by a user, the textual query and each test video may be compared, by matching their terms as in Equation 14. Finally, the test videos may be ranked by their measured similarity to the query and presented to the user.

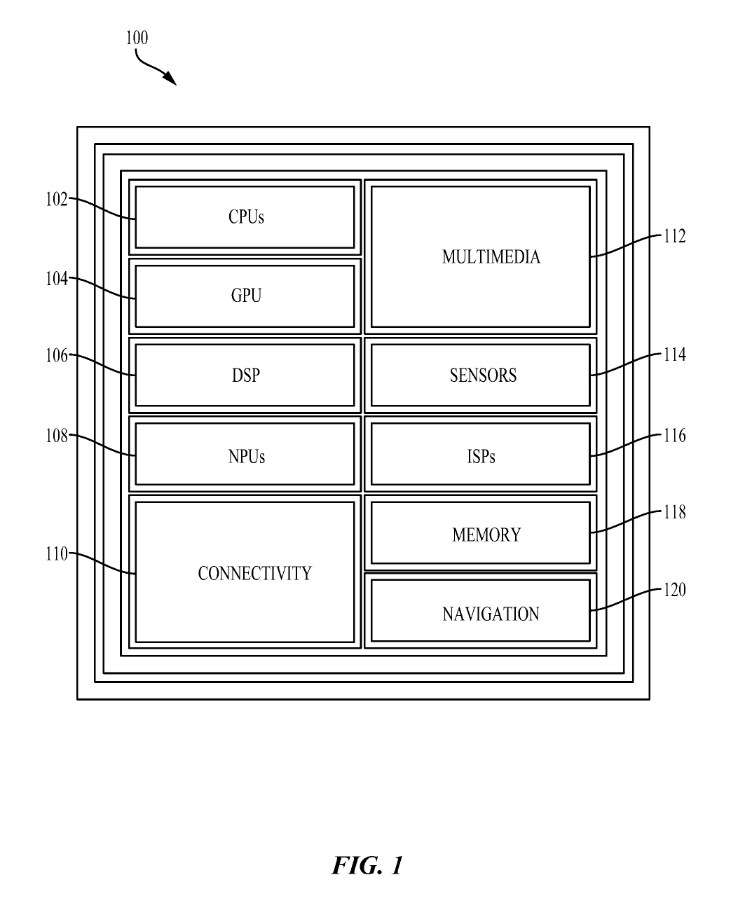

FIG. 1 illustrates an example implementation of the aforementioned embedding video for text search using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for jointly optimizing semantic predictability and semantic descriptiveness. The instructions loaded into the general-purpose processor 102 may also comprise code for learning the embedding based on terms included in a query and learning the embedding based on multimodal analysis of the video.

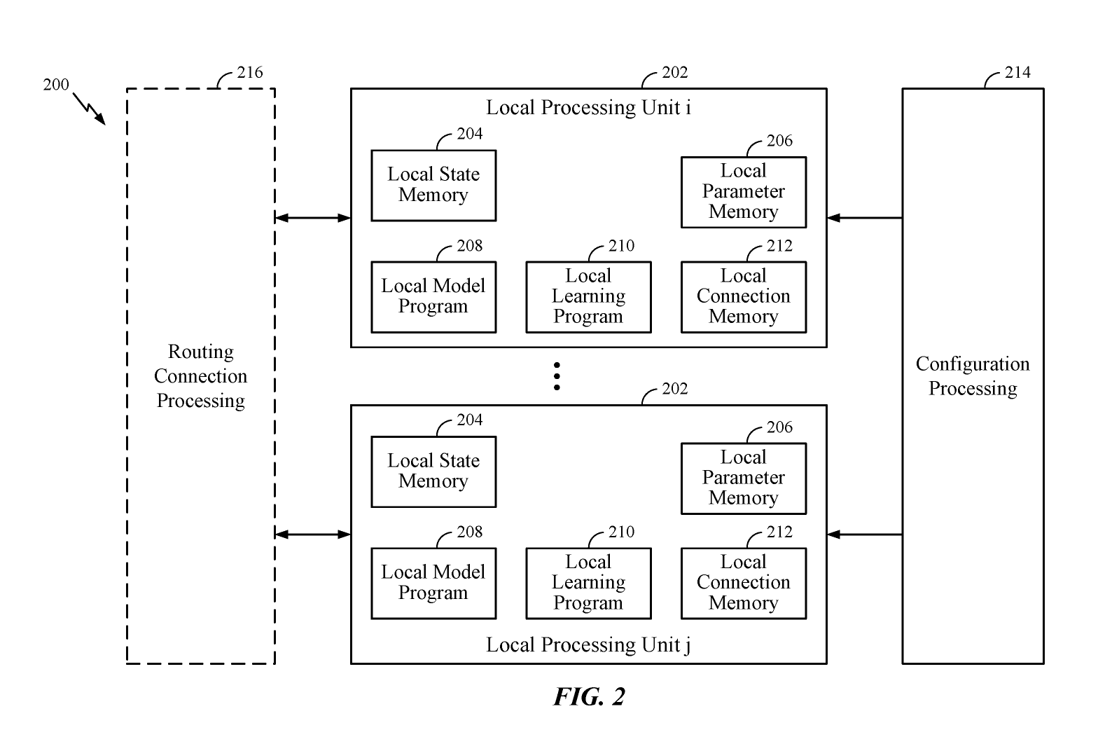

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

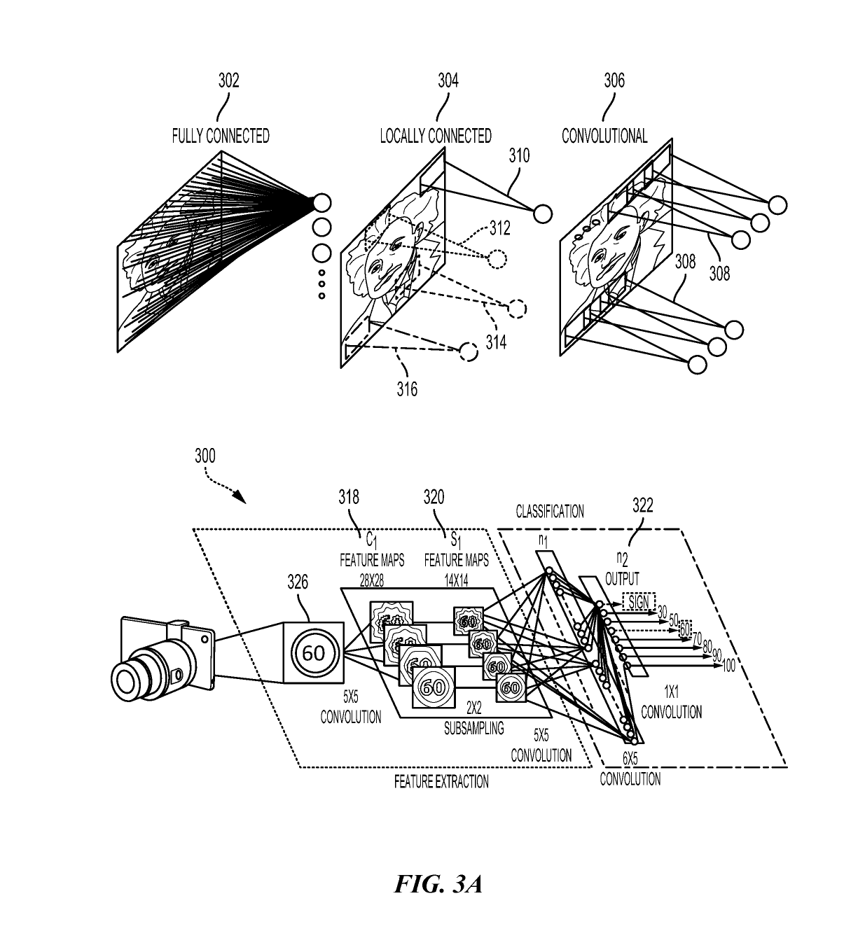

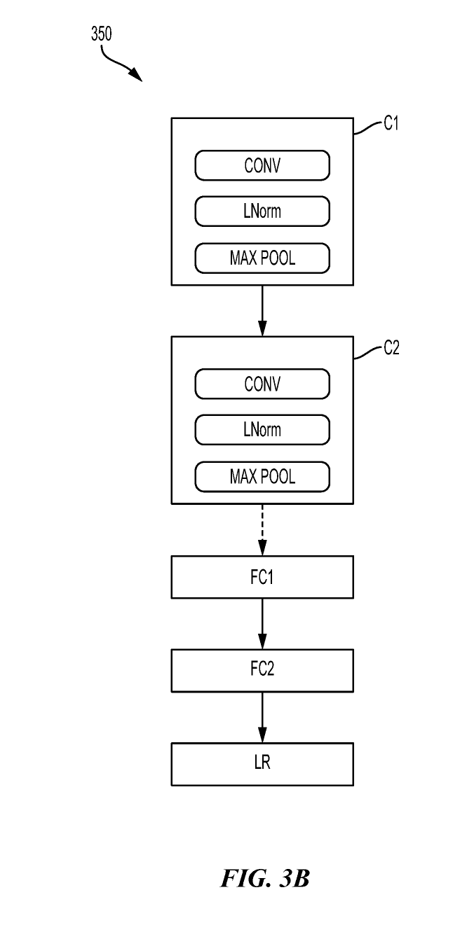

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

In one configuration, a machine learning model is configured for jointly optimizes semantic predictability and semantic descriptiveness by learning the embedding based on terms included in a query and based on multimodal analysis of the video. The model is also configured for predicts an event in the video based on the embedding. The model includes a jointly optimizing means for and/or predicting means. In one aspect, the a jointly optimizing means for and/or predicting means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

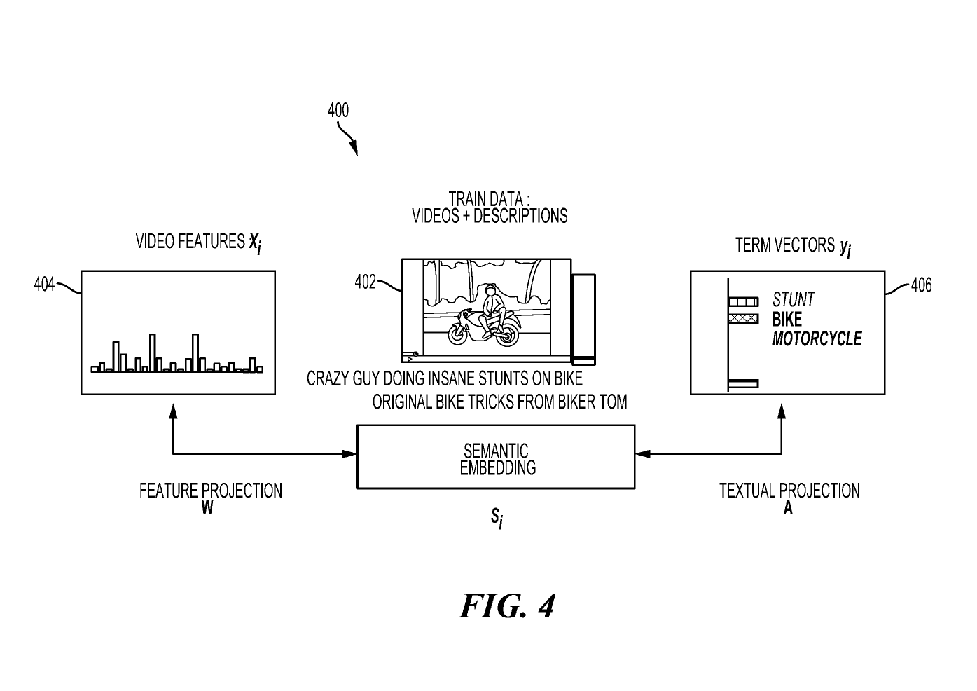

FIG. 4 is a block diagram illustrating an exemplary process 400 for training and embedding in accordance with aspects of the present disclosure. Referring to FIG. 4, a set of videos 402 from a training data set is provided. The videos 402, which may be retrieved from a repository of videos, for example, may include a text description. In the example of FIG. 4, a first video includes a text description “Crazy guy doing insane stunts on bike” and a second video (partially occluded) includes a text description “Original Bike Tricks from Biker Tom.” Although, each of the videos of FIG. 4 include a text description or label, this is merely for ease of explanation, and a label may not be included or the video may be unlabeled.

The text descriptions and any other text-based descriptions (e.g., subtitle information) associated with the video may be used to form term vectors 406 (yᵢ). In this example, using the video text descriptions, the term vectors may be formed and include the terms “stunt,” “bike” and “motorcycle.” The term vectors may further include synonyms for each of the detected terms. For example, the term vector could also include synonyms for bike such as motorbike, dirt bike and the like. A textual projection A may be determined based on the term vectors 406 (yᵢ).

Video features xᵢ may be extracted from the video. The video features 404 (xᵢ) may include appearance, motion, audio, like features and combinations thereof. For instance, the video features could include movement of the motorcycle, movement of the rider to a side facing position in the seat, the sound of the motorcycle, etc. These video features 404 (xᵢ) may be used to determine a feature projection W. The feature projection W and the textual projection A may, in turn, be used to compute an embedding sᵢ. The embedding may be determined or learned by jointly optimizing semantic predictability and semantic descriptiveness.

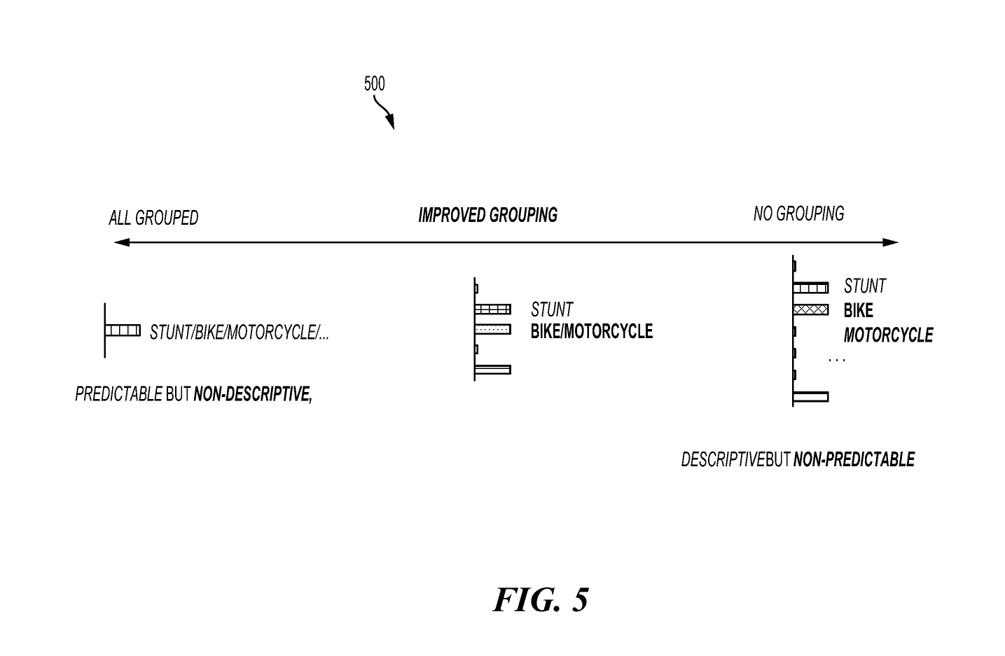

FIG. 5 is a line graph 500 illustrating an exemplary joint optimization based on the example of FIG. 4. As shown in FIG. 5, on the left side of the line graph, a proposed embedding includes a grouping of all of the identified terms (e.g., Stunt/Bike/Motorcycle). This grouping would be predictable, but may not be descriptive. That is, the embedding is likely to be recognized from the contents because each of the videos includes a stunt, a bike or a motorcycle. However, the embedding is not likely to be very descriptive because it includes all of the terms. In other words, a search of a data set including such an embedding would produce a larger number of results than desired (e.g., results in which the video includes bikes, motorcycles or stunts).

On the other hand, on the right side of the line graph, none of the identified terms are grouped. As such, the embedding is descriptive, but may not be predictable. As such, a search of a data set including such an embedding would produce fewer results than desired (e.g., only results in which the video includes a bike, a motorcycle and a stunt).

Using the joint optimization, an improved grouping may be determined. In the example of FIG. 5, only synonym words are grouped (e.g., motorcycle and bike). As such, descriptiveness and predictability are balanced so that a search of a data set including such an embedding may produce a more desirable set of results (e.g., results in which the video includes a stunt with a bike or a motorcycle).

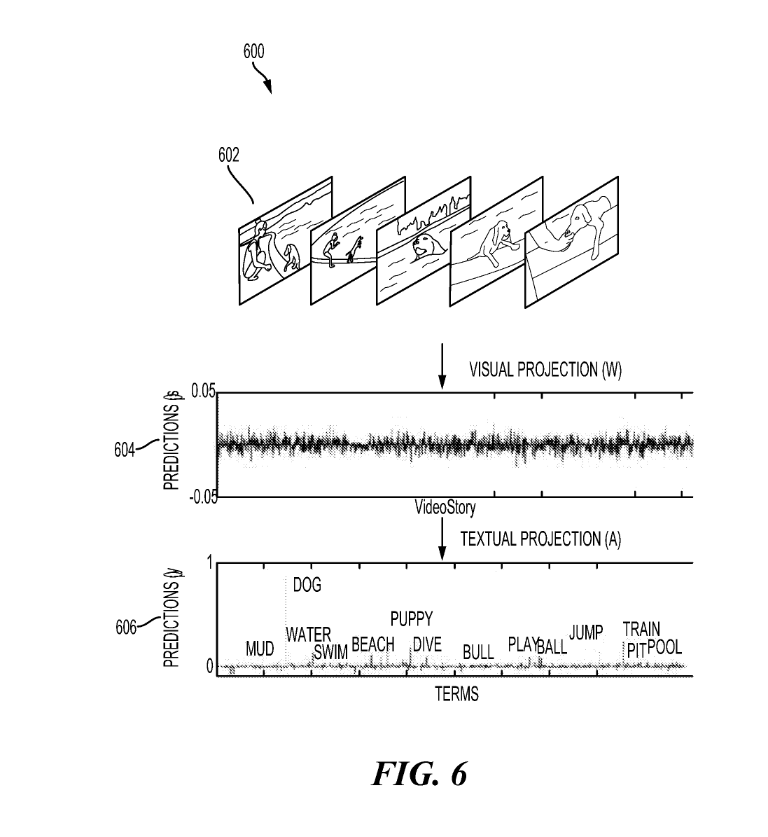

FIG. 6 is a diagram 600 illustrating exemplary prediction of contents of a video in accordance with aspects of the present disclosure. As shown in FIG. 6, a trained visual feature projection W and trained textual projection A may be applied to an unseen video 602 to predict the contents of the video (604). The trained visual feature projection W may be used to predict a representation from the video features (e.g., jumping dog or splashing water). The textual projection A may be used to predict term vectors (606) from the representation. In the term vectors 606, the most likely contents of the video are shown in larger text. In this example, the label dog may be associated with the video 602. In some aspects, additional terms may be included in the label (e.g., dive, train, and puppy).

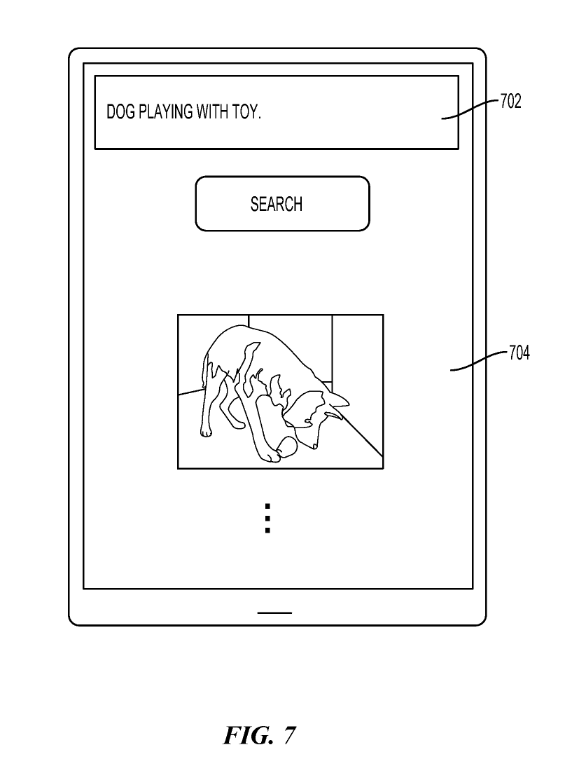

Accordingly, video search and retrieval may be improved. As illustrated in FIG. 7, a user may input a search query 702 such as “dog playing with toy” and in return, relevant videos 704 including a dog playing with a toy may be presented.

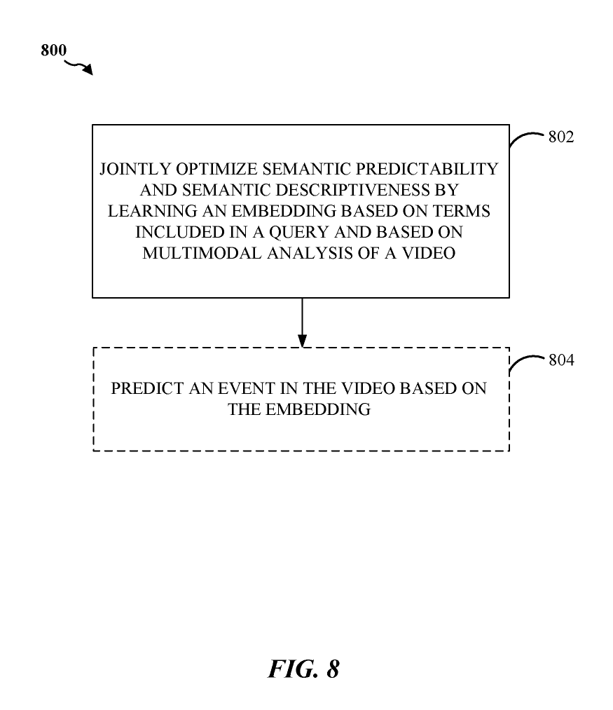

FIG. 8 illustrates a method 800 for embedding video for text search. In block 802, the process jointly optimizes semantic predictability and semantic descriptiveness by learning an embedding based on terms included in a query and based on multimodal analysis of a video.

In some aspects, the multimodal analysis is with respect to multimodal predictability loss of the embedding. In some aspects, descriptiveness loss is determined considering query analysis with respect to term sensitivity. Furthermore, in block 804, the process predicts an event in the video based on the embedding.

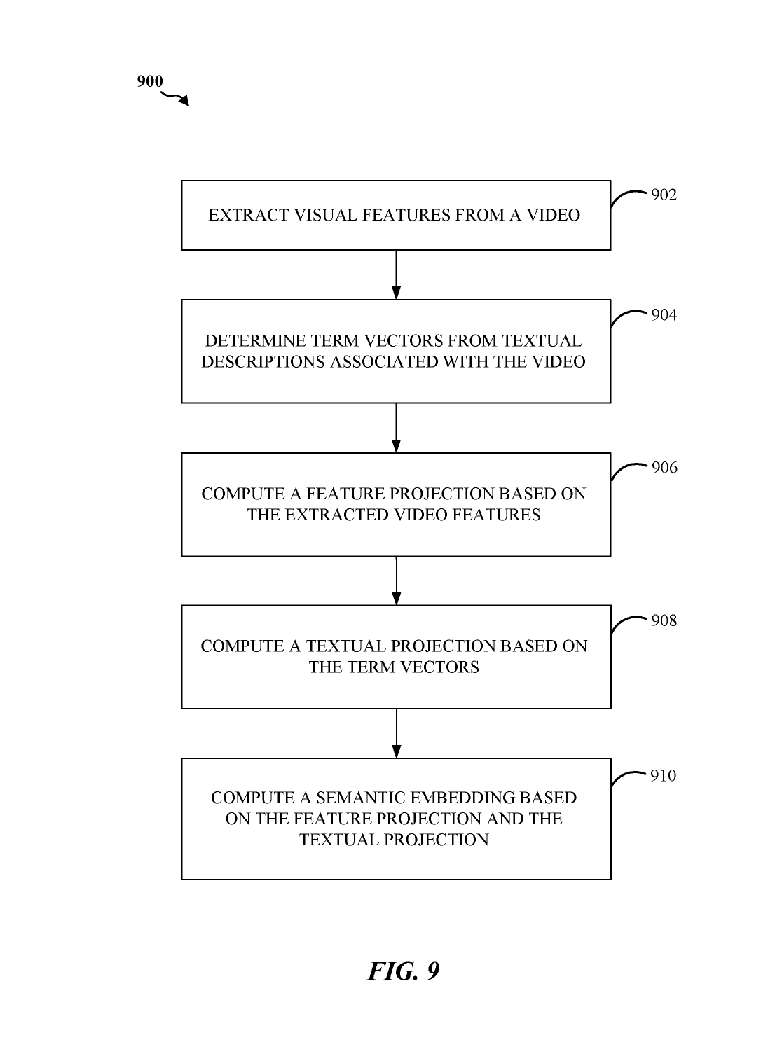

FIG. 9 illustrates a method 900 for training and embedding in accordance with aspects of the present disclosure. In block 902, the process extracts visual features from a video. The visual features may, for example, include appearance information, motion, audio, and/or like features. In block 904, the process determines term vectors from textual descriptions associated with the video. The text may be included in a title for the video or included within the video (e.g., subtitles), for example.

In block 906, the process computes a feature projection based on the extracted video features. In block 908, the process computes a textual projection based on the term vectors. In block, 910, the process computes a semantic embedding based on the feature projection and the textual projection. The semantic embedding may be computed by jointly optimizing semantic predictability and semantic descriptiveness.

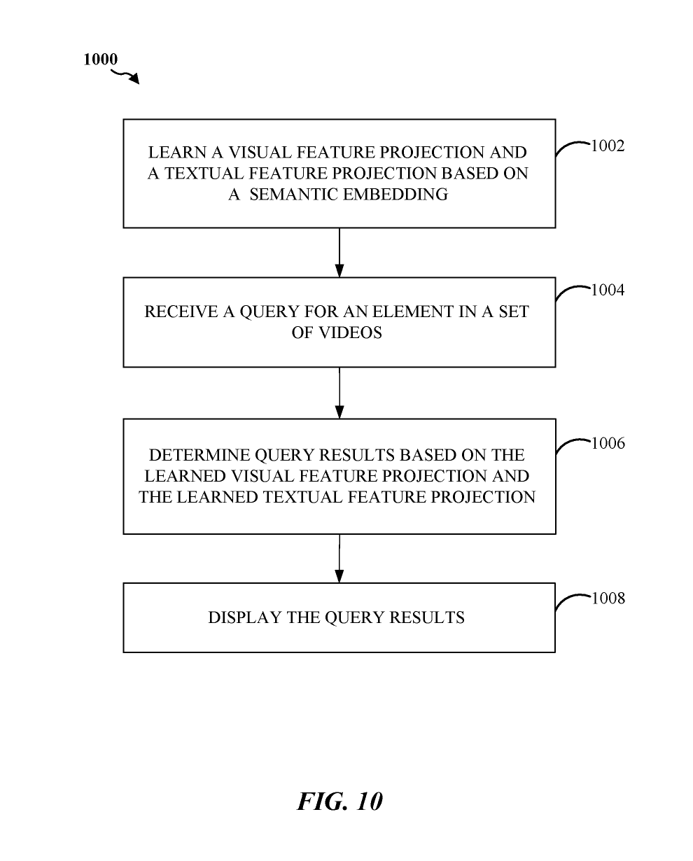

FIG. 10 illustrates a method 1000 for video retrieval in accordance with aspects of the present disclosure. In block 1002, the process learns a visual feature projection and a textual feature projection based on a sematic embedding. In block 1004, the process receives a query (e.g., a text-based query) for an element in a set of videos. In block 1006, the process determines query results based on the learned visual feature projection and the learned textual feature projection. The query results may, in turn, be displayed in block 1008.

In some aspects, the methods 800, 900 and 1000 may be performed by the SOC 100 (FIG. 1) or the system 200 (FIG. 2). That is, each of the elements of the methods 800, 900 and 1000 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of embedding a video for a text search, comprising:
jointly optimizing a semantic predictability and a semantic descriptiveness by:
learning the embedding based at least in part on terms included in a query; and
learning the embedding based at least in part on a multimodal analysis of the video.

2. The method of claim 1, in which the multimodal analysis is with respect to a multimodal predictability loss of the embedding.

3. The method of claim 1, in which an analysis of the query is with respect to the semantic descriptiveness.

4. The method of claim 1, in which a descriptiveness loss is determined considering an analysis of the query with respect to a term sensitivity.

5. The method of claim 1, further comprising predicting an event in the video based at least in part on the embedding.

6. An apparatus for embedding a video for a text search, comprising:
a memory; and
at least one processor coupled to the memory, the at least one processor configured:
to jointly optimize a semantic predictability and a semantic descriptiveness by:
learning the embedding based at least in part on terms included in a query; and
learning the embedding based at least in part on a multimodal analysis of the video.

7. The apparatus of claim 6, in which the multimodal analysis is with respect to a multimodal predictability loss of the embedding.

8. The apparatus of claim 6, in which an analysis of the query is with respect to the semantic descriptiveness.

9. The apparatus of claim 6, in which the at least one processor is further configured to determine a descriptiveness loss considering an analysis of the query with respect to a term sensitivity.

10. The apparatus of claim 6, in which the at least one processor is further configured to predict an event in the video based at least in part on the embedding.

11. An apparatus for embedding a video for a text search, comprising:
means for jointly optimizing a semantic predictability and a semantic descriptiveness by:
learning the embedding based at least in part on terms included in a query; and
learning the embedding based at least in part on a multimodal analysis of the video; and
means for predicting an event in the video based at least in part on the embedding.

12. The apparatus of claim 11, in which the multimodal analysis is with respect to a multimodal predictability loss of the embedding.

13. The apparatus of claim 11, in which an analysis of the query is with respect to the semantic descriptiveness.

14. The apparatus of claim 11, in which a descriptiveness loss is determined considering an analysis of the query with respect to a term sensitivity.

15. A non-transitory computer readable medium having encoded thereon program code for embedding a video for a text search, the program code being executed by a processor and comprising:
program code to jointly optimize a semantic predictability and a semantic descriptiveness by:
learning the embedding based at least in part on terms included in a query; and
learning the embedding based at least in part on a multimodal analysis of the video.

16. The non-transitory computer readable medium of claim 15, in which the multimodal analysis is with respect to a multimodal predictability loss of the embedding.

17. The non-transitory computer readable medium of claim 15, in which an analysis of the query is with respect to the semantic descriptiveness.

18. The non-transitory computer readable medium of claim 15, further comprising program code to determine a descriptiveness loss considering an analysis of the query with respect to a term sensitivity.

19. The non-transitory computer readable medium of claim 15, further comprising program code to predict an event in the video based at least in part on the embedding.
